(19) United States
(12) Patent Application Publication
(10) Pub. No.: US 2003/0222460 A1
(43) Pub. Date: Dec. 4, 2003

(54) Spare generator and device of engine

(76) Inventor: Ming Huang Chiang, Taipei (TW)

Correspondence Address: Ming Huang CHIANG, PO Box 82-144, TAIPEI, TW

(21) Appl. No.: 10/159,039

(22) Filed: Jun. 3, 2002

(51) Int. Cl. H02P 9/04; F02N 11/06

(52) U.S. Cl. 290/41

(57) ABSTRACT

A structure of a space generator system and device for engine is disclosed and the generator system characterized in that a ignition device leads current from a battery to a spark plug within the engine to ignite so as to drive the engine to operate, the power of the engine drives the generator so as to produce current to be stored within the battery, a manual driving device is provided so that the space generator device temporary stores kinetic energy and the ignition device releases the kinetic energy of the generator device to urge the engine generator to produce current to be leaded to the battery to ignite the spark plug so as to drive the engine to operated, thereby when the battery is exhausted, the generator can be operated manually and urgently ignite the engine.

### BACKGROUND OF THE INVENTION

(a) Field of the Invention

The present invention relates to a structure of a spare generator for an engine, and in particular a generator which generates electricity when a battery is exhausted. The spare generator and device can be manually operated when emergency electricity is required.

(b) Description of the Prior Art

FIG. 1 shows a conventional generator for an engine. Gasoline within the engine is used to ignite the engine to produce a force to push the piston of the engine so that the engine is operated. In this conventional generator for engine, battery is needed to produce electricity to ignite the engine in order for the generator to generate electricity. However, when the battery is exhausted, the engine cannot be ignited. This is commonly happened when the lighting system of a car has not been switched off. Accordingly, it is an object of the present invention to provide a generator system and device, wherein the above drawback can be overcome.

### SUMMARY OF THE INVENTION

Accordingly, it is an object of the present invention to provide structure of a space generator system and device for engine, characterized in that a ignition device leads current from a battery to a spark plug within the engine to ignite so as to drive the engine to operate, the power of the engine drives the generator so as to produce current to be stored within the battery, a manual driving device is provided so that the space generator device temporary stores kinetic energy and the ignition device releases the kinetic energy of the generator device to urge the engine generator to produce current to be leaded to the battery to ignite the spark plug so as to drive the engine to operated, thereby when the battery is exhausted, the generator can be operated manually and urgently ignite the engine.

Another object of the present invention is to provide a structure of spare generator system and device, wherein the housing of the engine body is provided with two magnetic poles and an electric brush, and a rotor is pivotally mounted between the two poles, one end of the rotor is provided with a belted wheel so that the belted wheel is interlinked to drive the engine, the belted wheel has a ratchet wheel pivotally mounted to the rotor, the other end of the rotor is provided with a driving wheel by means of a ratchet wheel and a rotating shaft is mounted pivotally to the rotor by a plurality of reverse direction ratchet wheels, the driving wheel is surrounded with driving cable having mounted with a restoration device for reciprocating the driving wheel, the rotating shaft is pivotally mounted with a torque device and a braking engine, and one side of the torque device is pivotally mounted an interlinked wheel by a ratchet wheel, and one side of the interlinked wheel is pivotally mounted to a driving wheel by a interlinked shaft so that a clockwise rotating restoration force is formed at the rotating shaft, and the braking device is used to control the opening or shutting of the rotational restoration force so as to produce an instantaneous current to provide the current to ignite the engine.

Yet another object of the present invention is to provide a structure of a spare generator system and device, wherein the restoration device comprises a top braking seat plate a compression spring and a top block, and the seat plate is fixed to the body of the generator device and one end thereof allows the driving line to pass through and the compression spring is mounted onto the driving line between the top brake seat plate and the driving wheel, and the top block is mounted at the compression spring corresponding to the other end of the driving line of the top brake seat plate.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart of a convention engine generator system.

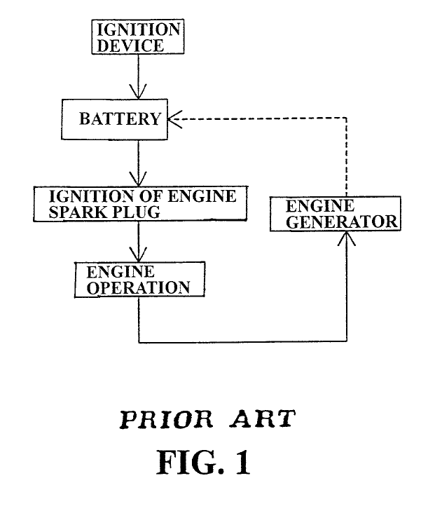

FIG. 2 is a system flowchart in accordance with the present invention.

FIG. 3 is a perspective exploded view of the generator system in accordance with the present invention.

FIG. 4 is an external perspective view of the generator system and device in accordance with the present invention.

FIG. 5 is a sectional view of the generator system and device in accordance with the present invention.

FIG. 6 is a sectional view along A-A of FIG. 5 in accordance with the present invention.

FIG. 7 is a sectional view along B-B of FIG. 5 in accordance with the present invention.

FIG. 8 is a sectional view along C-C of FIG. 5 in accordance with the present invention.

FIG. 9 is a sectional view along D-D of FIG. 5 in accordance with the present invention.

FIG. 10 is a schematic view showing the action of the hand-brake in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

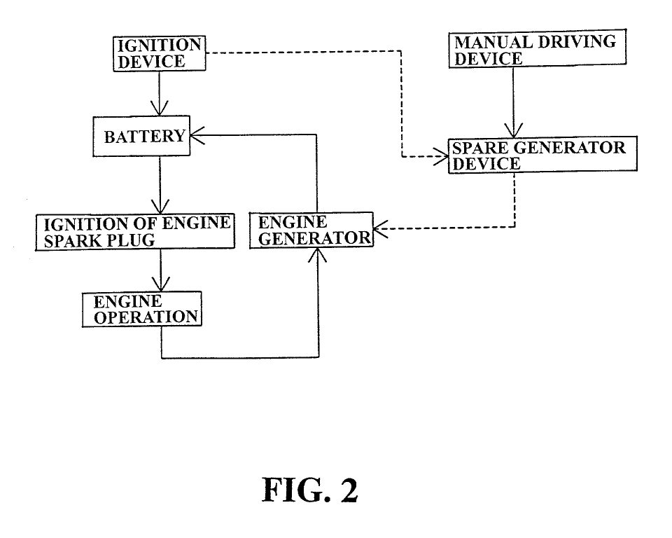

Referring to FIG. 2, there is shown a structure of a space generator system and device for engine, characterized in that a ignition device leads current from a battery to a spark plug within the engine to ignite so as to drive the engine to operate, the power of the engine drives the generator so as to produce current to be stored within the battery, a manual driving device is provided so that the space generator device temporary stores kinetic energy and the ignition device releases the kinetic energy of the generator device to urge the engine generator to produce current to be leaded to the battery to ignite the spark plug so as to drive the engine to operated, thereby when the battery is exhausted, the generator can be operated manually and urgently ignite the engine.

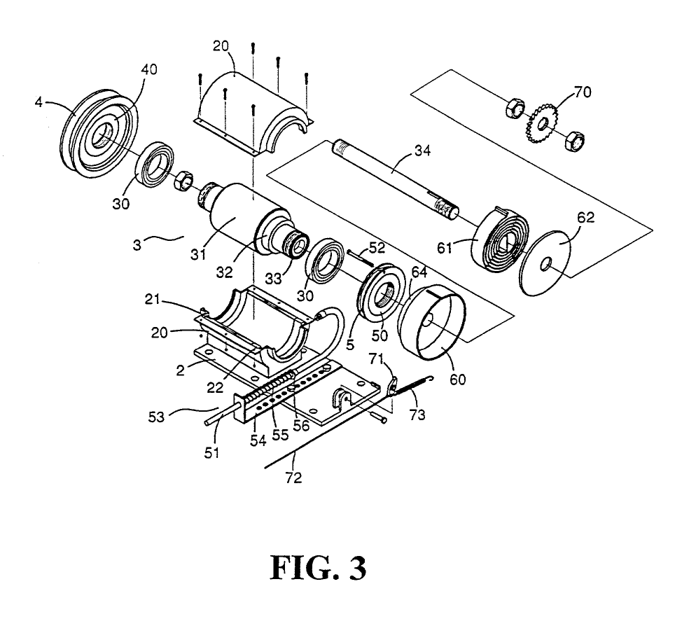

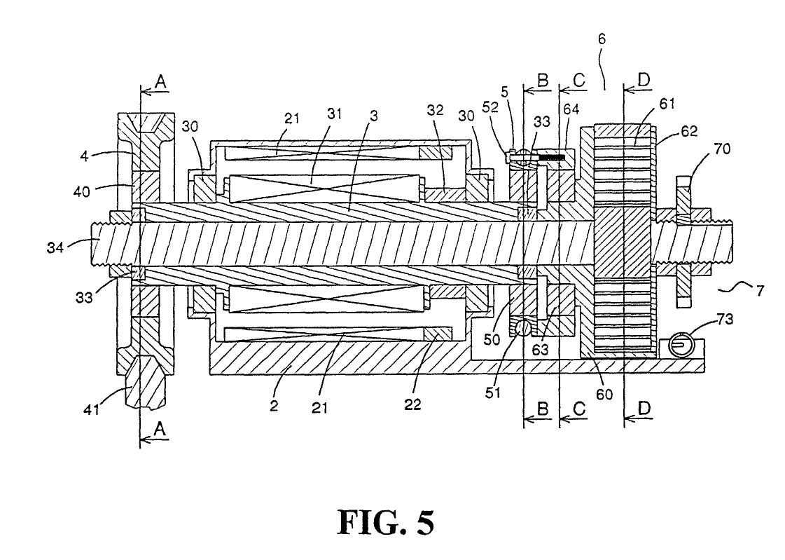

Referring to FIGS. 3 to 5, the spare generator for the engine of the present preferred embodiment comprises a engine body 2, a rotor 3, a belted wheel 7, and a driving wheel 5, a torque device 6, a braking device 7 and a hand-brake 8, wherein the engine body 2 is provided with two corresponding housing cover 20 and the housing cove 20 is provided with two magnetic poles 21 and an electric brush 22, and a rotor 3 is pivotally mounted between the two poles 21. One end of the rotor 3 is provided with a belted wheel 4 and the two end of the rotor 3 employ two bearings 30 so that the rotor is positioned between two magnetic poles 21. The belted wheel 4 is interlinked to drive the engine, the belted wheel 4 has a ratchet wheel 33 pivotally mounted to the rotor 3, the other end of the rotor 3 is provided with a driving wheel 5 by means of a ratchet wheel 40 and a rotating shaft 34 is mounted pivotally to the rotor 3 by a plurality of reverse direction ratchet wheels 40. The driving wheel 5 is surrounded with driving cable 51 having mounted with a restoration device 53 for reciprocating the driving wheel 5, the rotating shaft 34 is pivotally mounted with a torque device 6 and a braking engine 7, and one side of the torque device 6 is pivotally mounted an interlinked wheel 64 by a ratchet wheel 63, and one side of the interlinked wheel 63 is pivotally mounted to a driving wheel 5 by a interlinked shaft so that a clockwise rotating restoration force is formed at the rotating shaft 34, and the braking device 7 is used to control the opening or shutting of the rotational restoration force so as to produce an instantaneous current to provide the current to ignite the engine.

The restoration device 5 comprises a top braking seat plate54, a compression spring 55 and a top block 56, and the seat plate54 is fixed to the body 2 of the generator device and one end thereof allows the driving line 51 to pass through and the compression spring 55 is mounted onto the driving line 51 between the top brake seat plate 54 and the driving wheel 5, and the top block 56 is mounted at the compression spring 55 corresponding to the other end of the driving line 51 of the top brake seat plate 54.

The torque device 6 comprises a sleeve 60, an elastic element 61 and a cover plate 62, wherein the sleeve 60 is pivotally mounted on the rotating shaft 34 and one side thereof is a interlinked wheel 64 pivotally mounted by a clockwise ratchet wheel 63 and the elastic element 61 is a coiled spring and the external end is mounted onto the sleeve 60, and the inner end thereof is mounted to the rotational shaft 34 and the cover plate 62 is mounted to the sleeve 60 by the elastic element 61, and the inner side of the ratchet wheel 63 is mounted to the protruded edge at one side of the sleeve 60, and the outer side is mounted onto the interlinked wheel 64.

The braking device comprises a ratchet wheel, an engaging block a control line, and an elastic body, wherein the ratchet wheel is mounted onto the rotating shaft, and the braking block is pivotally mounted to the engine body, and the top end thereof is in engagement with the ratchet wheel and produce a braking effect, and the control line has one end mounted to the lower end of the engaging block and the other end of the control line is linked to an ignition switch, and the elastic body is mounted to the corresponding end of the control line, and one end thereof is mounted to the lower end of the braking block, and the other end is mounted to the engine body.

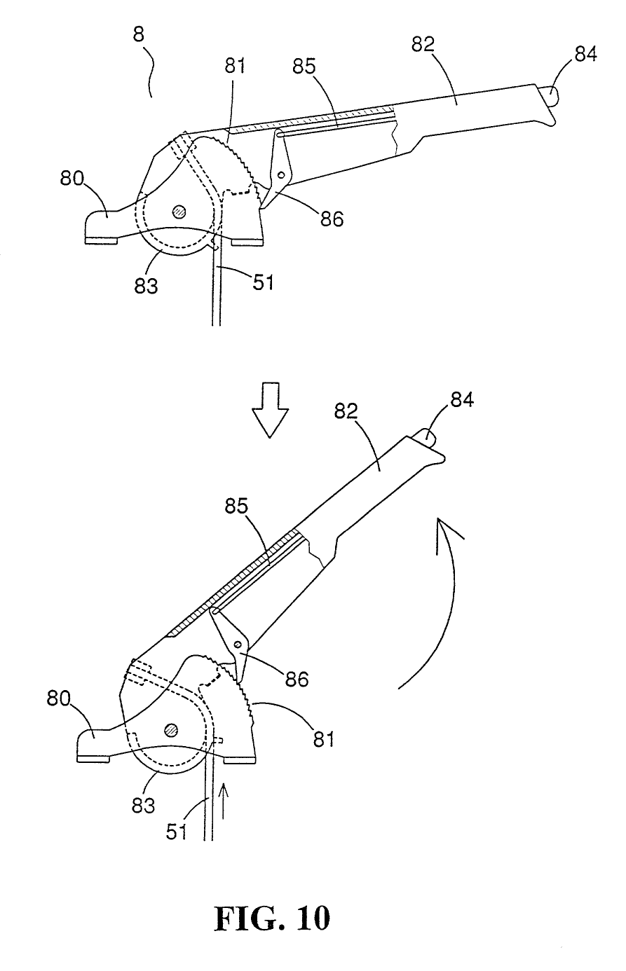

The hand brake is a pivotal seat mounted pivotally with a pulling rod, one side of the pivotal seat is a provided with a plurality of ratchet wheel and the interior of the pulling rod is pivotally mounted with an engaging block, and one end of the engaging block is engaged with the ratchet teeth of the pivotal seat so as to produce a positioning effect, and the other end is provide with a linking rod connected to the press button at the top end of the pulling rod, such that the press button links with the engaging block to achieve the control of positioning effect, and the two sides of the pulling rods is mounted with a circular arch-shape slot, and the slot is surrounded with a braking line and a driving line, and one end of the braking line and the driving line is fixed at one end of the slot. (Referring to FIG. 10)

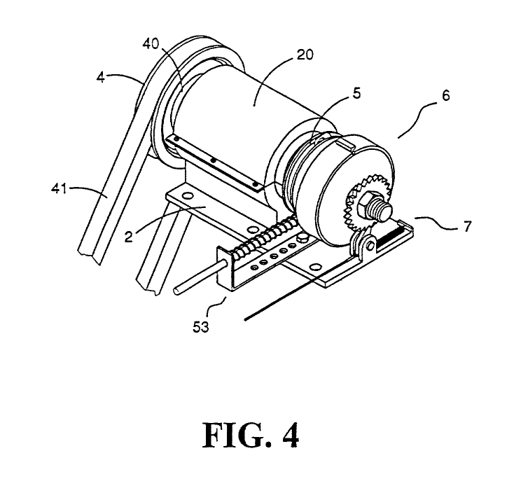

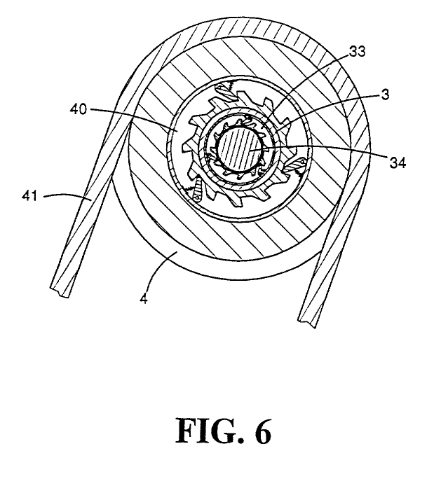

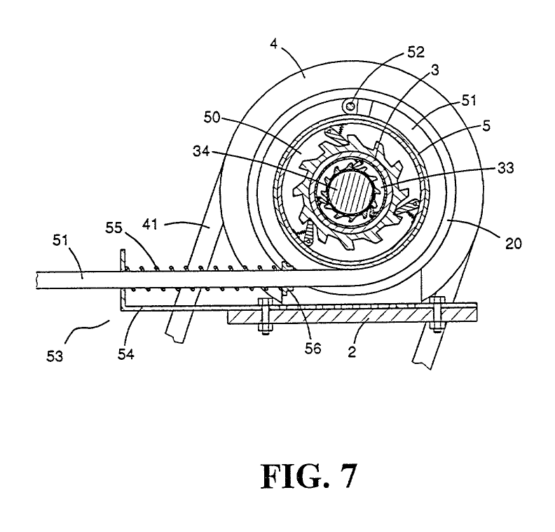

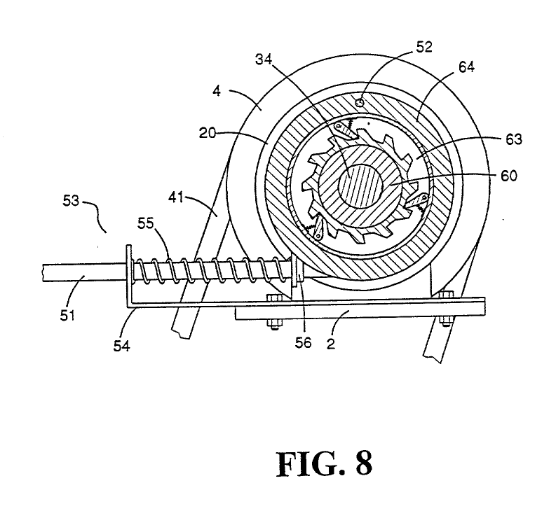

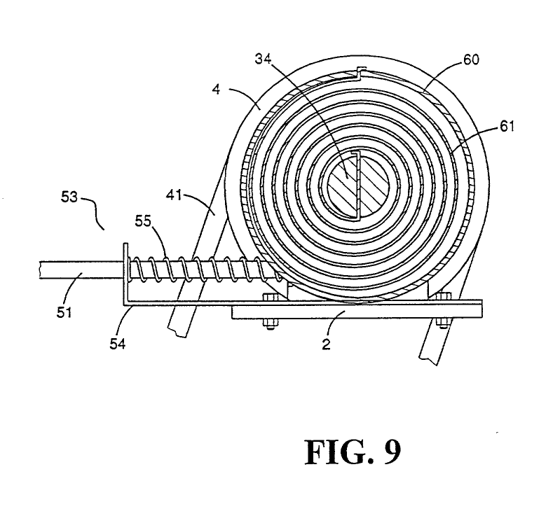

Referring to FIGS. 4 to 7, when the engine is in operation as a result of the battery, the belt 41 will drive the belted wheel 4 to rotate clockwise. The rotor 3 and the magnetic pole 21 will produce current to store within the battery. Referring to FIGS. 4 to 10, when the battery is exhausted, the driving line 51 is pulled upward the driving wheel 5 will rotate clockwise to compress the compression spring 55 as shown in FIG. 7. When the driving line 51 is released, the compression spring 55 will expand to push the driving wheel 5 as shown in FIG. 7.When the elastic element 61 is at a tightening condition, the engaging block 71 disengage from the ratchet wheel 70 by means of the control line 72, the rotating shaft 34 will restore to rotate clockwise and the magnetic pole 21 will produce current to ignite the engine. When the rotating shaft 34 drives the rotor 3 to rotate clockwise, the rotating shaft 34 will rotate within the belted wheel 4 and the driving wheel 5 (as shown in FIGS. 6 and 7).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a space generator system and device for engine, characterized in that a ignition device leads current from a battery to a spark plug within the engine to ignite so as to drive the engine to operate, the power of the engine drives the generator so as to produce current to be stored within the battery, a manual driving device is provided so that the space generator device temporary stores kinetic energy and the ignition device releases the kinetic energy of the generator device to urge the engine generator to produce current to be leaded to the battery to ignite the spark plug so as to drive the engine to operated, thereby when the battery is exhausted, the generator can be operated manually and urgently ignite the engine.

2. A structure of a spare generator system and device for engine, characterized in that the housing of the engine body is provided with two magnetic poles and an electric brush, and a rotor is pivotally mounted between the two poles, one end of the rotor is provided with a belted wheel so that the belted wheel is interlinked to drive the engine, the belted wheel has a ratchet wheel pivotally mounted to the rotor, the other end of the rotor is provided with a driving wheel by means of a ratchet wheel and a rotating shaft is mounted pivotally to the rotor by a plurality of reverse direction ratchet wheels, the driving wheel is surrounded with driving cable having mounted with a restoration device for reciprocating the driving wheel, the rotating shaft is pivotally mounted with a torque device and a braking engine, and one side of the torque device is pivotally mounted an interlinked wheel by a ratchet wheel, and one side of the interlinked wheel is pivotally mounted to a driving wheel by a interlinked shaft so that a clockwise rotating restoration force is formed at the rotating shaft, and the braking device is used to control the opening or shutting of the rotational restoration force so as to produce an instantaneous current to provide the current to ignite the engine.

3. The spare generator of claim 2, wherein the restoration device comprises a top braking seat plate a compression spring and a top block and the seat plate is fixed to the body of the generator device and one end thereof allows the driving line to pass through and the compression spring is mounted onto the driving line between the top brake seat plate and the driving wheel, and the top block is mounted at the compression spring corresponding to the other end of the driving line of the top brake seat plate.

4. The spare generator of claim 2, wherein the torque device comprises a sleeve, an elastic element and a cover plate, wherein the sleeve is pivotally mounted on the rotating shaft and one side thereof is a interlinked wheel pivotally mounted by a clockwise ratchet wheel and the elastic element is a coiled spring and the external end is mounted onto the sleeve, and the inner end thereof is mounted to the rotational shaft and the cover plate is mounted to the sleeve by the elastic element, and the inner side of the ratchet wheel is mounted to the protruded edge at one side of the sleeve, and the outer side is mounted onto the interlinked wheel.

5. The spare generator of claim 2, wherein the braking device comprises a ratchet wheel, an engaging block a control line, and an elastic body, wherein the ratchet wheel is mounted onto the rotating shaft, and the braking block is pivotally mounted to the engine body, and the top end thereof is in engagement with the ratchet wheel and produce a braking effect, and the control line has one end mounted to the lower end of the engaging block, and the other end of the control line is linked to an ignition switch, and the elastic body is mounted to the corresponding end of the control line, and one end thereof is mounted to the lower end of the braking block, and the other end is mounted to the engine body.

6. The spare generator of claim 5, wherein the ignition switch at one end of the control line is an ignition switch for a car.

7. The spare generator system and device for engine of claim 1, wherein the driving line is connected to the hand-brake having a pivotal seat mounted pivotally with a pulling rod, one side of the pivotal seat is a provided with a plurality of ratchet wheel and the interior of the pulling rod is pivotally mounted with an engaging block, and one end of the engaging block is engaged with the ratchet teeth of the pivotal seat so as to produce a positioning effect, and the other end is provide with a linking rod connected to the press button at the top end of the pulling rod, such that the press button links with the engaging block to achieve the control of positioning effect, and the two sides of the pulling rods is mounted with a circular arch-shape slot, and the slot is surrounded with a braking line and a driving line, and one end of the braking line and the driving line is fixed at one end of the slot.
